(19) United States
(12) Patent Application Publication
(10) Pub. No.: US 2015/0352982 A1
(43) Pub. Date: Dec. 10, 2015

(54) SEAT DEVICE

(71) Applicant: TS TECH CO., LTD., Asaka-shi, Saitama (JP)

(72) Inventor: Masato WATANABE, Shioya-gun (JP)

(73) Assignee: TS TECH CO., LTD., Asaka-shi, Saitama (JP)

(21) Appl. No.: 14/758,386

(22) PCT Filed: Dec. 26, 2013
(86) PCT No.: PCT/JP2013/084941

§ 371 Date: Jun. 29, 2015

(30) Foreign Application Priority Data
Dec. 28, 2012 (JP) 2012-287046
Dec. 28, 2012 (JP) 2012-287051
Dec. 28, 2012 (JP) 2012-287060

(51) Int. Cl. B60N 2/22; B60N 2/46; B60N 2/68

(52) U.S. Cl. CPC B60N 2/22; B60N 2/686; B60N 2/4606; B60N 2/688

(57) ABSTRACT

The object of the present invention is to reduce the thickness of a movable frame. A seat device includes a seat back frame; and a movable frame which is arranged inside the seat back frame and which tilts freely in front and back directions with respect to the seat back frame. The movable frame is formed of plate members. The movable frame can be thinner comparing to a movable frame formed of pipe material.

### TECHNICAL FIELD

The present invention relates to a seat device, and particularly relates to a seat device to be mounted on a vehicle.

### BACKGROUND ART

Conventionally, with respect to a seat device of a vehicle or the like, there has been known a seat device on which a movable frame that can tilt freely in the front and back directions with respect to a seat back frame is mounted (for example, see Patent Document 1). Usually, such a movable frame is formed of pipe material.

### PRIOR ART DOCUMENTS

### Patent Documents

Patent Document 1: Utility Model Application Laid-Open Publication Shou58-93266

### DISCLOSURE OF THE INVENTION

### Problems to be Solved by the Invention

Improvement in strength of individual parts of a seat device has always been a problem, and naturally, there is a similar request with respect to a movable frame. As ways to improve strength of a movable frame formed of pipe material, thickening the pipe material and increasing the diameter thereof can be easily thought of. However, in such methods, the thickness of the movable frame itself increases and this leads to increase in the size of the seat device.

In view of the above, an object of the present invention is to reduce the thickness of the movable frame.

### Means for Solving the Problem

To solve the problem described above, the invention according to claim 1 is a seat device, comprising: a seat back frame; and a movable frame which is arranged inside the seat back frame and which tilts freely in front and back directions with respect to the seat back frame, wherein the movable frame is formed of plate members.

The invention according to claim 2 is the seat device according to claim 1, wherein the movable frame includes: left and right side frames which are each formed of a plate member; and a connecting member which is formed of a plate member and which connects upper parts of the left and right side frames.

The invention according to claim 3 is the seat device according to claim 2, wherein the upper parts of the left and right side frames are respectively curved and extended toward inside and the connecting member is connected to the extended parts.

The invention according to claim 4 is the seat device according to claim 3, wherein the upper parts of the left and right side frames are formed so as to have cross-sectional U-shapes opened frontward, and the connecting member is arranged inside the cross-sectional U-shapes at the upper parts of the left and right side frames.

The invention according to claim 5 is the seat device according to any one of claims 2 to 4, wherein a center part of the connecting member is formed to have a convex toward a front.

The invention according to claim 6 is the seat device according to any one of claims 2 to 5, wherein the movable frame further includes left and right attachment frames which are each formed of a plate member, which are fixed at respective lower parts of the left and right side frames and which are attached to the seat back frame so as to rotate freely, and the attachment frames are formed so as to be widened toward connection parts with the seat back frame from fixation parts with the left and right side frames.

The invention according to claim 7 is the seat device according to any one of claims 2 to 6, wherein the left and right side frames and the connecting member are curved out so as to form a convex toward a back as a whole when seen from above.

The invention according to claim 8 is the seat device according to any one of claims 1 to 7, further comprising a seat pad engaging with the movable frame, wherein pad supporting members for supporting parts of the seat pad from below are provided at left and right back side frames of the seat back frame.

The invention according to claim 9 is the seat device according to claim 1, further comprising a belt guide bracket to which a belt guide of a seatbelt is to be fixated, wherein the seat back frame includes left and right back side frames and an upper frame which connects upper parts of the left and right back side frames, the belt guide bracket is attached to an upper end part of at least one of the left and right back side frames, the upper frame is formed of plate members, and an end part of the upper frame is connected to a part near the belt guide bracket in the at least one of the left and right back side frames and the end part of the upper frame has a shape where a width thereof widens toward the belt guide bracket.

The invention according to claim 10 is the seat device according to claim 9, wherein the end part of the upper frame is connected directly to the belt guide bracket.

The invention according to claim 11 is the seat device according to claim 9 or 10, wherein a lower part of the end part of the upper frame is curved so that a connecting position with the part near the belt guide bracket is arranged below a lower end part of the belt guide bracket.

The invention according to claim 12 is the seat device according to any one of claims 9 to 11, wherein the upper frame is formed of two plate members, and a front-side plate member and a back-side plate member are assembled so that inside thereof is hollow.

The invention according to claim 13 is the seat device according to claim 12, wherein both the front-side plate member and the back-side plate member are connected to the belt guide bracket.

The invention according to claim 14 is the seat device according to claim 13, wherein cutouts for fitting the belt guide bracket is provided at the connecting position of the front-side plate member and the back-side plate member with the belt guide bracket.

The invention according to claim 15 is the seat device according to any one of claims 12 to 14, wherein the belt guide bracket includes: a first bracket member which engages with the upper end part of the at least one of the left and right back side frames so as to cover a back of the at least one of the left and right back side frames; and a second bracket member which engages with the upper end part of the at least one of the left and right back side frames so as to cover a front of the at least one of the left and right back side frames, wherein the first bracket member includes left and right first walls which are arranged so as to have the upper end part of the at least one of the left and right back side brackets between the left and right first walls, the second bracket member includes left and right second walls which are arranged so as to have the first walls of the first bracket member between the left and right second walls, and a connecting position of the belt guide bracket with the front-side plate member is arranged at a back of a step formed by the first walls and the second walls.

The invention according to claim 16 is the seat device according to any one of claims 9 to 15, comprising the movable frame which is arranged inside the seat back frame and which tilts freely in the front and back directions with respect to the seat back frame, wherein the movable frame and the seat back frame are curved out so as to form a convex toward a back when seen from above.

The invention according to claim 16 is the seat device according to claim 1, further comprising an armrest bracket for supporting an armrest, wherein the seat back frame includes left and right back side frames, the armrest bracket is fixed to at least one of the left and right back side frames, the back side frame to which the armrest bracket is fixated is divided into an upper side frame and a lower side frame in up and down directions, a lower end part of the upper side frame and an upper end part of the lower side frame are unified so as to overlap, and the armrest bracket is fixed to the overlapping region of the upper side frame and the lower side frame.

The invention according to claim 18 is the seat device according to claim 17, wherein the lower side frame is arranged so as to overlap the upper side frame from outside, and the armrest bracket is fixed to the lower side frame in the overlapping region.

The invention according to claim 19 is the seat device according to claim 17 or 18, wherein the armrest bracket supports the armrest so that the armrest rotates freely, and the armrest bracket is fixated to the overlapping region so that a rotary shaft of the armrest projects forward from the overlapping region.

The invention according to claim 20 is the seat device according to any one of claims 17 to 19, further comprising a side frame connecting member which is bridged from a part near the overlapping region to the other back side frame.

### Effect of the Invention

According to the invention of claim 1, since the moveable frame is formed of plate members, the movable frame can be thinner comparing to a movable frame formed of pipe material.

According to the invention of claim 2, since the upper end parts of the left and right side frames are connected by the connecting member, the parts near the upper parts of the side frames can be connected firmly by the connecting member.

According to the invention of claim 3, since the upper end parts of the left and right side frames respectively curve and extend toward inside, rigidity of the side frames themselves can be improved by the curved parts.

According to the invention of claim 4, since the upper end parts of the left and right side frames respectively have cross-sectional U-shapes opened frontward, rigidity of the upper end parts of the side frames themselves can be improved by the cross-sectional U-shaped parts.

Moreover, since the connecting member is arranged inside the cross-sectional U-shapes at the upper end parts of the left and right side frames, rigidity of the connecting member after assembly can also be improved.

According to the invention of claim 5, since the center part of the connecting member curves out so as to form a convex frontward, rigidity of the connecting member itself can be improved by the convex part.

According to the invention of claim 6, the attachment frames are formed so that their widths gradually widen as approaching the lower end parts which are connecting parts with the back side frames from the upper end parts which are fixation parts with the left and right side frames. Therefore, large areas can be assured at the connecting parts with the back side frames and the attachment frames can be respectively attached stably to the back side frames.

Further, since only the necessary parts are made to be wider, the attachment frames can be prevented from becoming large.

According to the invention of claim 7, the left and right side frames and the connecting member are curved out so as to form a convex toward the back as a whole when seen from above. Therefore, a passenger can be supported so as to be held from behind. Therefore, the comfort level of the passenger can be improved.

According to the invention of claim 8, the left and right back side frames are respectively provided with the pad supporting members which support parts of the seat pad from below. Therefore, the seat pad can be prevented from sinking down by the pad supporting members and the comfort level of the passenger can be assured.

According to the invention of claim 9, one end part of the upper frame which is formed of plate members has a shape that gradually widens as approaching near the belt guide bracket and is connected to a part near the belt guide bracket. Therefore, the upper frame can be connected to the part near the belt guide bracket with a greater contact area. Thereby, while preventing the upper frame from becoming large as a whole, the force applied to the part near the belt guide bracket can be received by a greater area. Therefore, the attachment rigidity of the belt guide bracket can be improved and stability of the seatbelt can be improved even more.

According to the invention of claim 10, one end part of the upper frame is directly connected to the belt guide bracket. Therefore, the force applied to the belt guide bracket can be received directly by the one end part of the upper frame and the attachment rigidity of the belt guide bracket can be improved even more.

According to the invention of claim 11, the lower part of one end part of the upper frame is curved so that the connecting position of the upper frame and the part near the belt guide bracket be arranged below the lower end part of the belt guide bracket. Therefore, the one end part of the upper frame can be widened. Thus, the connection strength between the upper frame and the belt guide bracket can be improved.

According to the invention of claim 12, the upper frame is an assembly of the front-side plate member and the back-side plate member which are the two plate members, the front and back, so that the inside thereof is hollow. Therefore, while making the upper frame be lighter, its rigidity can also be assured.

According to the invention of claim 13, since both the front-side plate member and the back-side plate member are connected to the belt guide bracket, the force applied to the belt guide bracket can be received directly by the front-side plate member and the back-side plate member. Therefore, the attachment rigidity of the belt guide bracket can be improved even more.

According to the invention of claim 14, at the connecting positions of the belt guide bracket to the front-side plate member and the back-side plate member, the cutouts for fitting the belt guide bracket are provided. Therefore, a space can be assured by the cutouts and a sufficient size of the belt guide bracket can be assured.

According to the invention of claim 15, the connecting position of the belt guide bracket with the front-side plate member is arranged at the back of the step formed by the first walls of the first bracket member and the second walls of the second bracket member. Therefore, the connecting position can be fit in the space formed by the step and can be formed in a compact manner.

According to the invention of claim 16, since the movable frame and the seat back frame are curved so as to have a convex toward the back when seen from above, both of the movable frame and the seat back frame can be arranged in a compact manner.

According to the invention of claim 17, the back side frames are respectively divided in the up and down directions and the armrest brackets are respectively fixed to the overlapping regions of the upper side frames and the lower side frames. Therefore, the armrest brackets are respectively to be supported by the overlapping regions. Since the overlapping regions are parts where two plate members are overlapped, the armrest brackets can be supported more firmly comparing to the case where they are each supported by one plate member, and the attachment rigidity of the armrest brackets can be improved.

According to the invention of claim 18, the armrest brackets are respectively fixed to the lower side frames in the overlapping regions. Therefore, the load the armrest brackets receive can be supported by the lower side frames which are more stable comparing to the upper side frames. Thus, stability of the armrests and the armrest brackets can be improved.

According to the invention of claim 19, the armrest brackets are respectively fixed to the overlapping regions so that the rotary shafts of the armrests project frontward from the overlapping regions. As described above, since two plate members are overlapped at each of the overlapping regions, the regions have high rigidity. Further, the armrest brackets are respectively fixed to the overlapping regions so that the rotary shafts of the armrests project frontward from the overlapping regions. Therefore, while holding back the length of the armrests themselves, their length at use can be assured.

According to the invention of claim 20, the side frame connecting member is bridged from the part near the overlapping region to the back side frame on the other side. Therefore, the parts near the overlapping regions are reinforced by the side frame connecting member and the attachment rigidity of the armrest bracket can be improved even more.

### BRIEF DESCRIPTION OF DRAWINGS

FIG. 1 is a schematic view showing a main configuration of a seat device according to the embodiment.

FIG. 2 is a front view showing an outline configuration of a seat back frame and a movable frame according to the embodiment.

FIG. 3 is a schematic view of the outline configuration of the seat back frame and the movable frame of FIG. 2 when seen diagonally from the right front side.

FIG. 4 is a schematic view of the outline configuration of the seat back frame and the movable frame of FIG. 2 when seen diagonally from the left front side.

FIG. 5 is a schematic view of an enlarged overlapping region in a left back side frame where an upper side frame and a lower side frame overlap according to the embodiment.

FIG. 6 is a side view of the overlapping region of FIG. 5.

FIG. 7 is a back view showing an outline configuration of a belt guide bracket according to the embodiment.

FIG. 8 is an under view of the belt guide bracket of FIG. 7.

FIG. 9 is a schematic view showing an outline configuration of an upper frame according to the embodiment.

FIG. 10 is a schematic view showing a connected state of the upper frame and the belt guide bracket according to the embodiment.

FIG. 11 is the schematic view showing the connected state of the upper frame and the belt guide bracket according to the embodiment.

FIG. 12 is the schematic view showing the connected state of the upper frame and the belt guide bracket according to the embodiment.

FIG. 13 is a schematic view showing an outline configuration of the movable frame according to the embodiment.

FIG. 14 is a schematic view showing an outline configuration of a right-side attachment frame according to the embodiment.

FIG. 15 is a top view of an outline configuration of the seat back frame and the movable frame according to the embodiment when seen from above.

FIG. 16 is an enlarged schematic view showing a positional relation between the seat back frame, the movable frame and a part of a seat pad according to the embodiment.

### BEST MODE FOR CARRYING OUT THE INVENTION

Hereinafter, an embodiment for carrying out the present invention will be described by using the drawings. Although various limitations that are technically preferred in order to carry out the present invention are included in the embodiment described below, the scope of the invention is not limited to the following embodiment and examples shown in the drawings in any way.

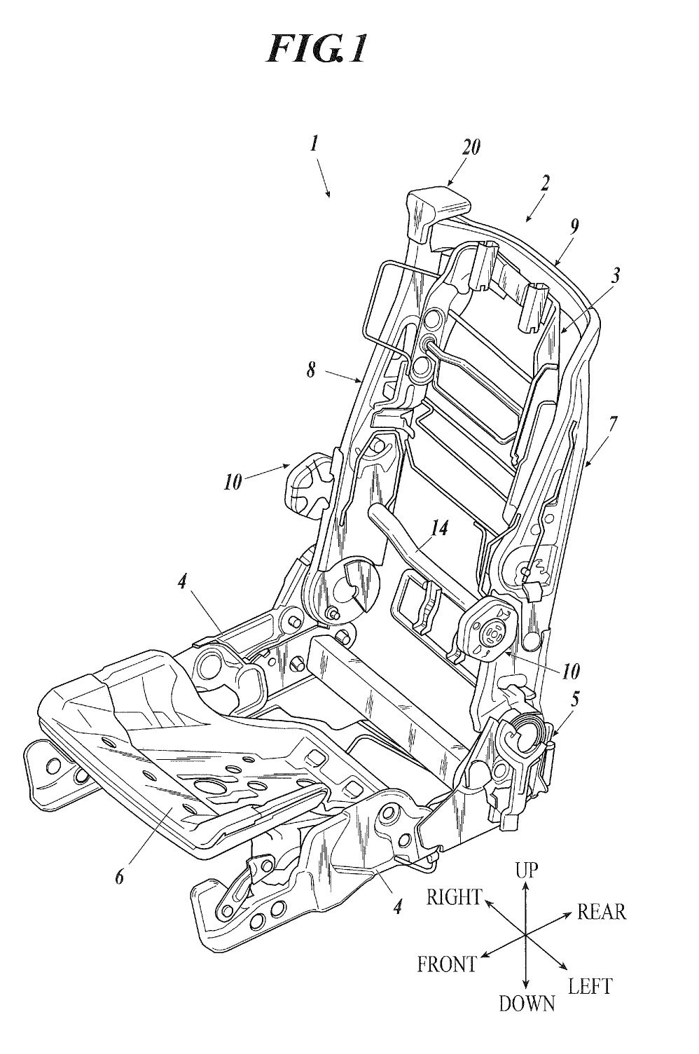

FIG. 1 is a schematic view showing a main configuration of a seat device according to the embodiment. As shown in FIG. 1, a seat device 1 includes a seat back frame 2, a movable frame 3 which is arranged inside the seat back frame 2 and which can tilt freely in the front and back directions with respect to the seat back frame 2, a pair of left and right cushion side frames 4 which are respectively arranged at the left and right parts of the lower part of the seat back frame 2, a reclining mechanism 5 which tilts the seat back frame 2 with respect to the cushion side frames 4 and a seat frame 6 which is arranged between the left and right cushion side frames 4 forming a pair and which supports a cushion pad (not shown in the drawing).

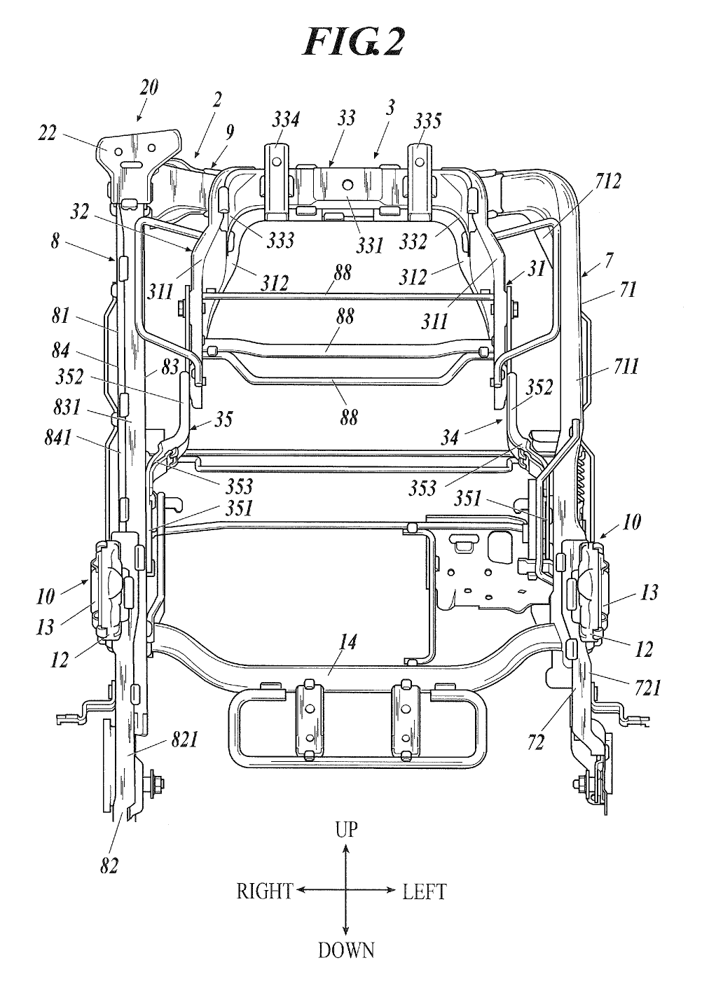

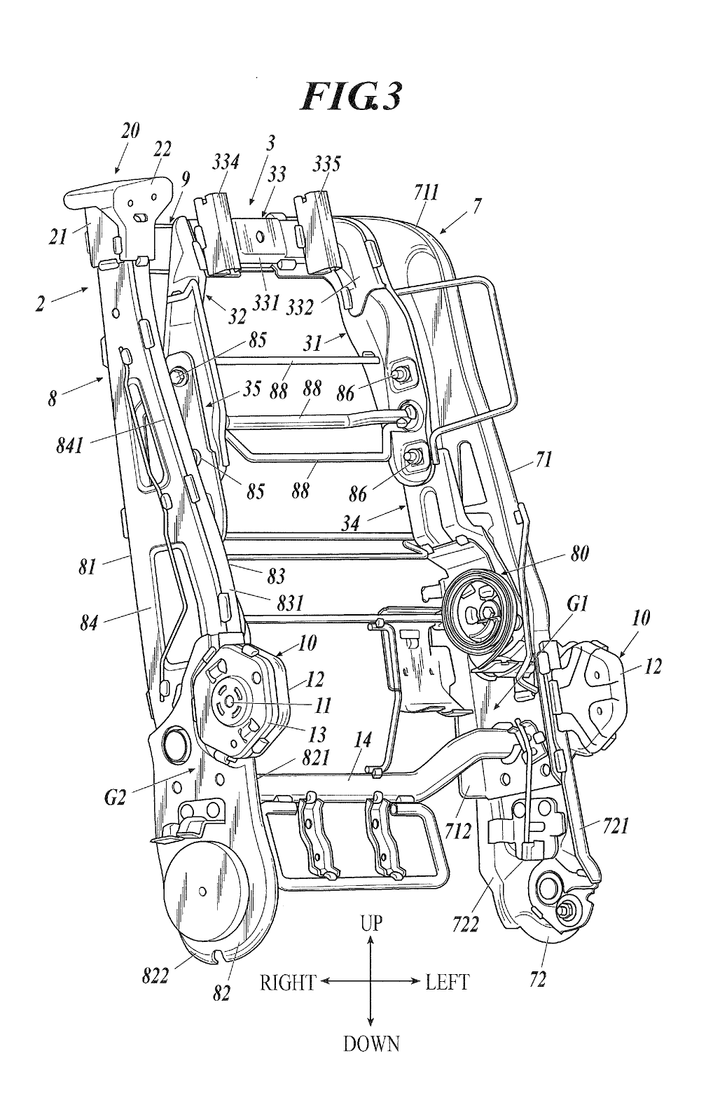

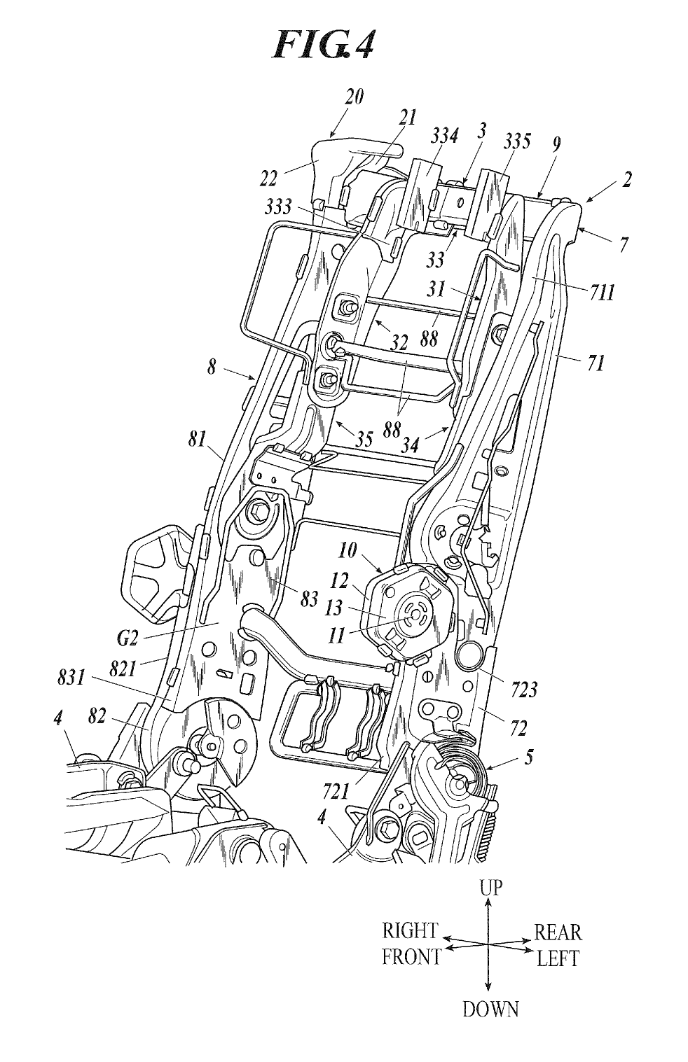

FIG. 2 is a front view showing an outline configuration of the seat back frame 2 and the movable frame 3, FIG. 3 is a schematic view of the outline configuration of the seat back frame 2 and the movable frame 3 when seen diagonally from the right front side, and FIG. 4 is a schematic view of the outline configuration of the seat back frame 2 and the movable frame 3 when seen diagonally from the left front side.

As shown in FIGS. 2 to 4, the seat back frame 2 includes left and right back side frames 7 and 8 and an upper frame 9 which connects the upper parts of the left and right back side frames 7 and 8.

The left back side frame 7 is divided in two, the upper side frame 71 and the lower side frame 72, in the up and down directions.

With respect to the lower side frame 72, the lower end part thereof is connected to the back end part of the left cushion side frame 4 so as to rotate freely. The lower side frame 72 is formed of one sheet of metal plate, and ribs 721 and 722 which extend inward are respectively formed at the front and back edges of the lower side frame 72 along the up and down directions. Further, at the back of the upper end part of the lower side frame 72, a cutout 723 which forms a convex downward is formed.

The upper side frame 71 is formed of one sheet of metal plate and while it is formed along the up and down directions as a whole, only the upper end part thereof is curved inward. Ribs 711 and 712 which extend inward are respectively formed at the front and back edges of the upper side frame 71 along the up and down directions. The ribs 711 and 712 are also formed continuously at the curved part near the upper end of the upper side frame 71. Further, the rib 711 is formed at the upper edge of the upper end part and the rib 712 is formed at the lower edge of the upper end part.

The lower end part of the upper side frame 71 is arranged between the front and back ribs 721 and 722 at the upper end part of the lower side frame 72. In such way, the lower side frame 72 is arranged so as to overlap the upper side frame 71 from outside.

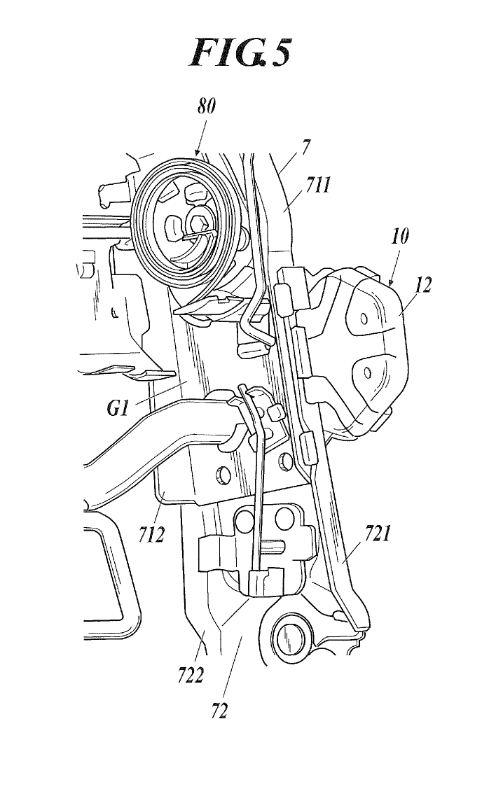

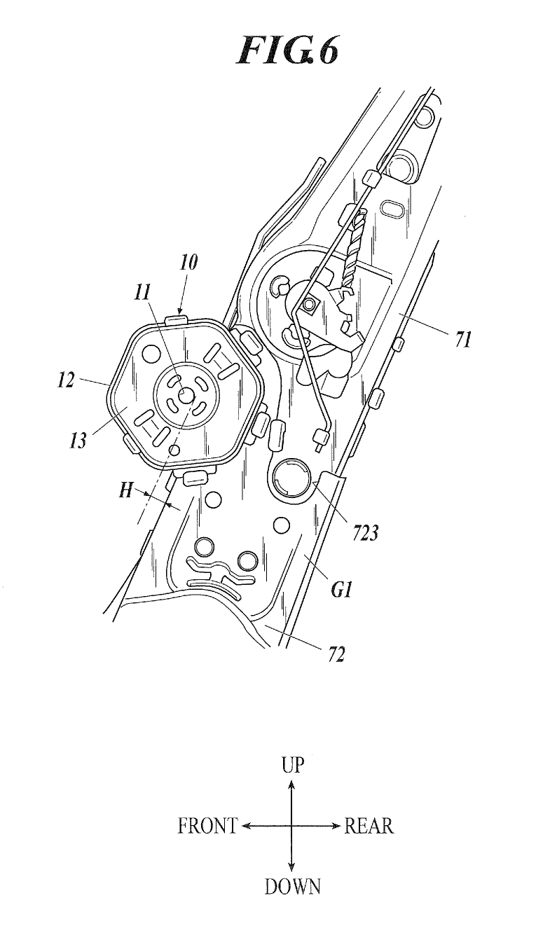

FIG. 5 is a schematic view showing an enlarged overlapping region G1 in the left back side frame 7 where the upper side frame 71 and the lower side frame 72 overlap, and FIG. 6 is a side view of the overlapping region G1.

As shown in FIGS. 5 and 6, an armrest bracket 10 which supports an armrest (not shown) is provided at the lower side frame 72 in the overlapping region G1. The armrest bracket 10 is formed in an approximately regular hexagon shape when seen from a side, and a rotary shaft 11 of an armrest is to be held at the center part of the armrest bracket 10 so as to rotate freely. The armrest bracket 10 is fixated at the front side part of the overlapping region G1 so that the rotary shaft 11 projects frontward from the overlapping region G1 for the length corresponding to the space H. In such way, the armrest bracket 10 and the cutout 723 of the lower side frame 72 face each other in the front and back directions.

The armrest bracket 10 is provided with a box-shaped unit 12 which opens outwardly and which is fixated at the lower side frame 72 and a cover unit 13 which covers the opened part of the box-shaped unit 12. With the box-shaped unit 12 and the cover unit 13, the armrest bracket 10 is hollow inside and its rigidity is improved.

As shown in FIGS. 2 to 4, the right back side frame 8 is divided in two, an upper side frame 81 and a lower side frame 82, in the up and down directions.

With respect to the lower side frame 82, the lower end part thereof is connected to the back end part of the right cushion side frame 4 so as to rotate freely. The lower side frame 82 is formed of one sheet of metal plate, and ribs 821 and 822 which extend inward are respectively formed at the front and back edges of the lower side frame 82 along the up and down directions.

The upper side frame 81 is formed of two metal plates which are an inside frame 83 and an outside frame 84. The inside frame 83 extends in the up and down directions, and ribs 831 and 832 which extend outward are respectively formed at the front and back edges of the inside frame 83 along the up and down directions. The outside frame 84 extends in the up and down directions so as to face the inside frame 83, and ribs 841 and 842 which extend inward are continuously formed at the front and back edges of the outside frame 84 in the up and down directions.

The outside frame 84 is assembled to the inside frame 83 so that the ribs 841 and 842 are fit inside the ribs 831 and 832 of the inside frame 83. In such way, the right upper side frame 81 is hollow inside.

The lower end part of the upper side frame 81 is arranged between the front and back ribs 821 and 822 at the upper end part of the lower side frame 82. In such way, the lower side frame 82 is arranged so as to overlap the upper side frame 81 from outside. The overlapping region G2 where the upper side frame 81 and the lower side frame 82 overlap each other in the right back side frame 8 is arranged at the position that faces the overlapping region G1 in the left back side frame 7.

Between the cutout 723 near the left-side overlapping region G1 and the right-side overlapping region G2, a pipe-like side frame connecting member 14 which extends in the left and right is bridged.

At the right-side overlapping region G2, similarly to the left-side overlapping region G1, an armrest bracket 10 is fixated thereto. The right-side armrest bracket 10 has a configuration basically the same as that of the left-side armrest bracket 10. Therefore, same symbols are used for the same parts and their description is omitted.

At the upper end part of the right back side frame 8, the belt guide bracket 20 to which the belt guide of a seatbelt (not shown) is to be fixated is attached. The belt guide bracket 20 will be described later.

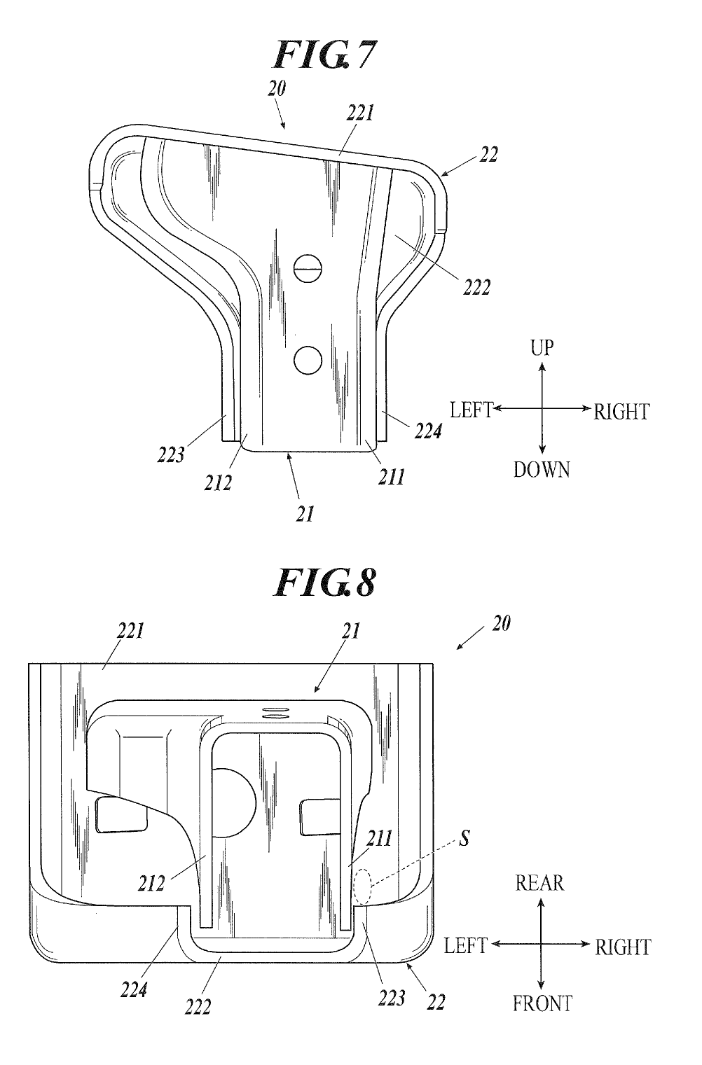

FIG. 7 is a back view showing an outline configuration of the belt guide bracket 20 and FIG. 8 is an under view of the belt guide bracket 20. As shown in FIGS. 7 and 8, the belt guide bracket 20 includes a first bracket member 21 which engages with the upper end part of the right back side frame 8 so as to cover the back side thereof and a second bracket member 22 which engages with the upper end part of the right back side frame 8 so as to cover the front side thereof.

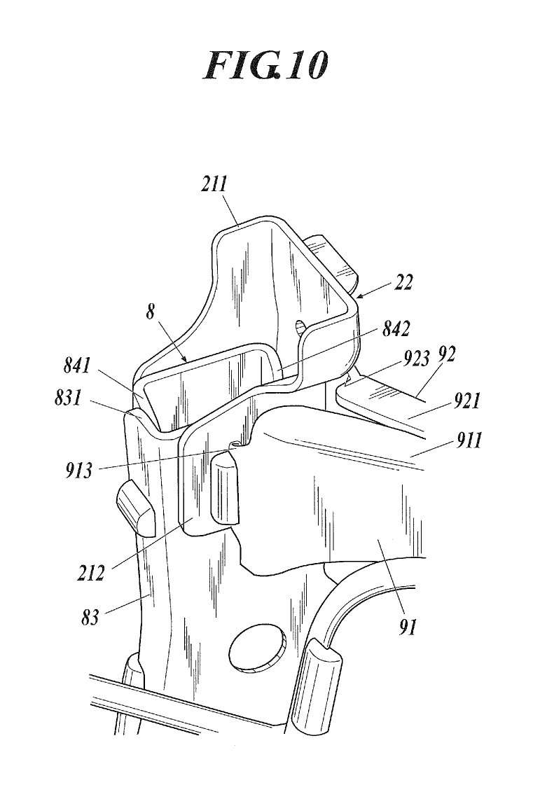

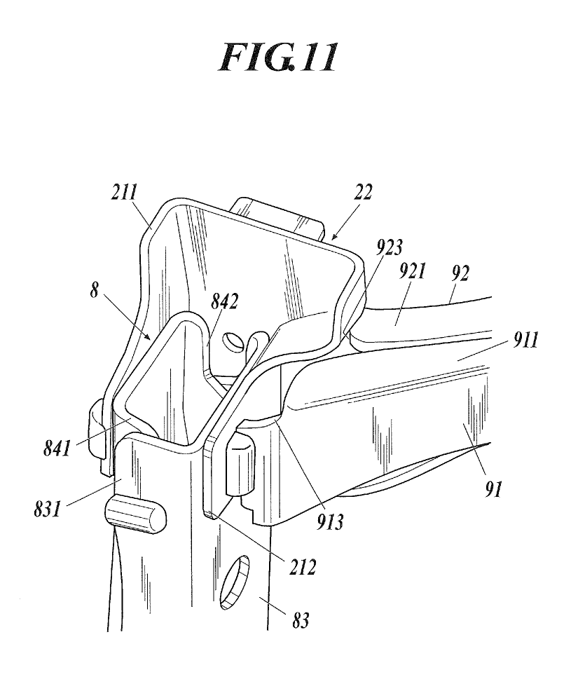

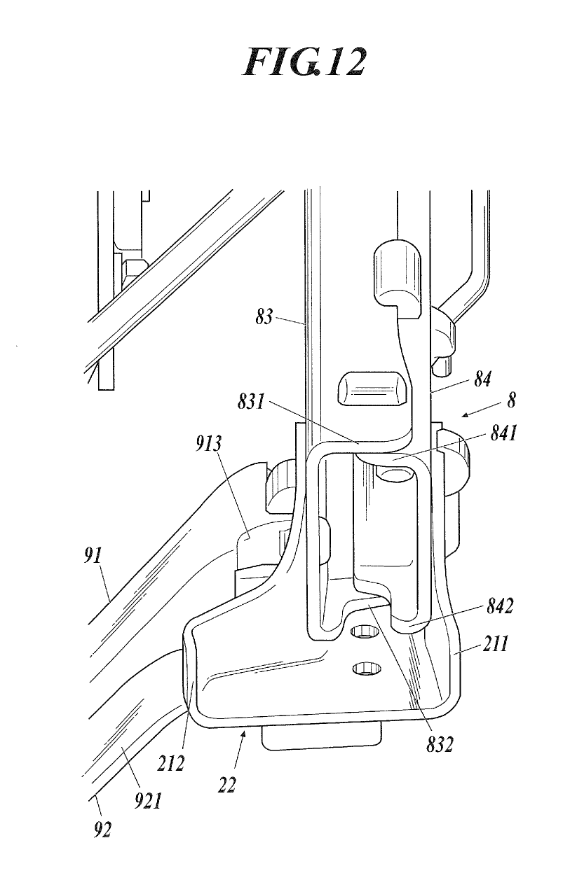

With respect to the first bracket member 21, the upper part thereof is formed so as to have a wider width in the left and right directions comparing to the lower part thereof. The upper end of the first bracket member 21 abuts the top unit 221 of the second bracket member 22 from inside. The first bracket member 21 further includes the left and right first walls 211 and 212 which are arranged so as to have the upper end part of the right back side frame 8 therebetween, the left and right first walls 211 and 212 respectively arranged on the left and right sides of the upper end part of the right back side frame (see FIGS. 10 to 12).

The second bracket member 22 is formed so that the upper part thereof has a wider width in the left and right directions comparing to the lower part thereof. The second bracket member 22 includes the top unit 221 to which the belt guide (not shown) is fixated, a front unit 222 which extends downward from the front end part of the top unit 221 and left and right second walls 223 and 224 which respectively extend backward from the left and right edges of the front unit 222 and which are arranged so as to have the first walls 211 and 212 of the first bracket member 21 therebetween, the second walls 223 and 224 respectively arranged on the left side of the first wall 212 and the right side of the first walls 211.

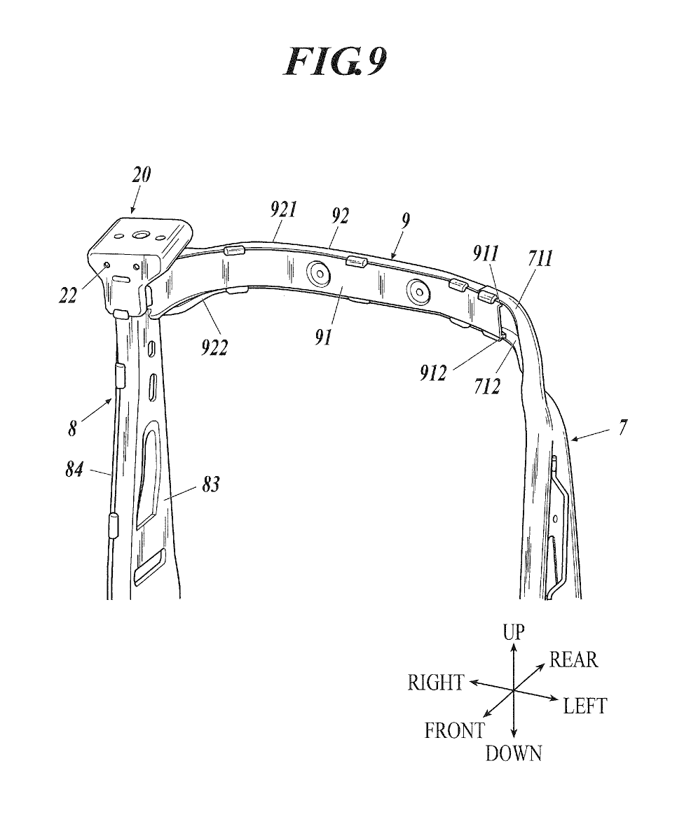

FIG. 9 is a schematic view showing an outline configuration of the upper frame 9.

The upper frame 9 curves out so as to form a convex toward the back, and the upper frame 9 is formed of two plate members which are the front-side plate member 91 and the back-side plate member 92. At the upper and lower end parts of the front-side plate member 91, ribs 911 and 912 which extend backward are respectively extended along the left and right directions. On the other hand, at the upper and lower end parts of the back-side plate member 92, ribs 921 and 922 which extend frontward are respectively extended along the left and right directions. The front-side plate member 91 and the back-side plate member 92 are assembled so that the ribs 911 and 912 of the front-side plate member 91 are to be fit inside the ribs 921 and 922 of the back-side plate member 92. In such way, the front-side plate member 91 and the back-side plate member 92 form a hollow space inside thereof.

The front-side plate member 91 has a length that projects more to the left comparing to the back-side plate member 92 after they are assembled.

FIGS. 10 to 12 are schematic views showing connection states of the upper frame 9 and the belt guide bracket 20. In FIGS. 10 to 12, the second bracket member 22 of the belt guide bracket 20 is omitted. As shown in FIGS. 10 to 12, one end part which is the right side of the upper frame 9 is directly connected to the belt guide bracket 20. In particular, the front-side plate member 91 of the upper frame 9 is formed in a shape that gradually widens as approaching the one end part at the right side. The one end part of the front-side plate member 91 is connected to the first wall 211 at the left side of the first bracket member 21 by welding. The connecting position of the first wall 211 and the front-side plate member 91 is arranged at the back of the step formed by the first wall 211 and the second wall 223 (see the oval S in FIG. 8). The lower end of the one end part of the front-side plate member 91 is arranged below the lower end of the first bracket member 21.

The back-side plate member 92 of the upper frame 9 is also formed in a shape that gradually widens as approaching the one end part at the right side. The one end part of the back-side plate member 92 is connected to the back surface of the first bracket member 21 by welding. The lower end of the one end part of the back-side plate member 92 is arranged below the lower end of the first bracket member 21.

At the connecting positions in the front-side plate member 91 and the back-side plate member 92 where the belt guide bracket 20 is connected, cutouts 913 and 923 for fitting the belt guide bracket 20 are respectively formed.

Next, the connection state of the upper frame 9 with the left back side frame 7 will be described. As shown in FIG. 9, the other end part of the back-side plate member 92 is connected to the upper end part of the left back side frame 7. As described above, the front-side plate member 91 is set to have a length so as to project more to the left comparing to the back plate member 92 after assembly. Therefore, the other end part of the front-side plate member 91 is to be fit between the ribs 711 and 712 at the upper end part of the left back side frame 7. In such way, the other end part of the front-side plate member 91 is to be connected so as to overlap the left back side frame 7 from the front over a range larger than the connection region of the back-side plate member 92 and the left back side frame 7.

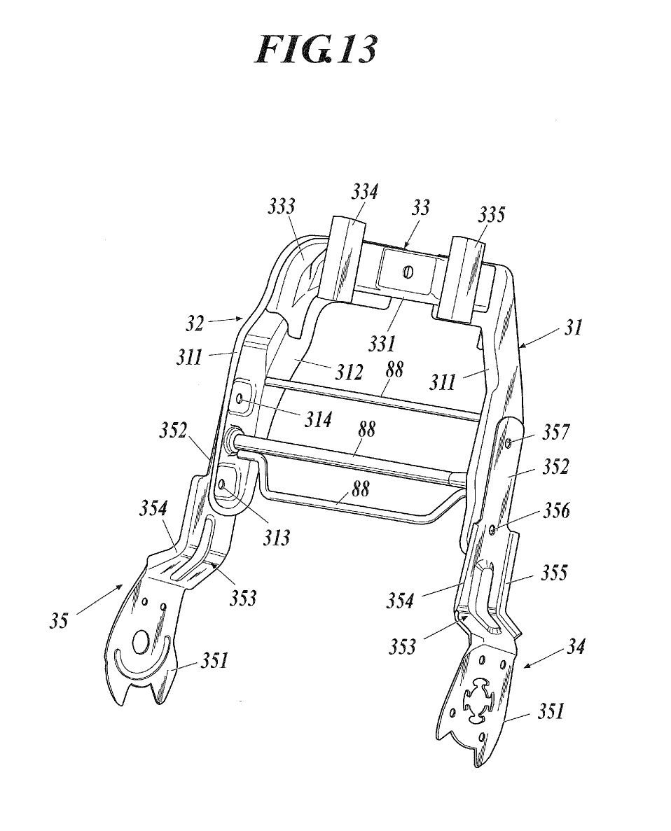

Next, the movable frame 3 will be described in detail. FIG. 13 is a schematic view showing an outline configuration of the movable frame 3.

As shown in FIG. 13, the movable frame 3 includes left and right side frames 31 and 32 formed of plate-like members, a connecting member 33 which is formed of a plate-like member and which connects the upper end parts of the left and right side frames 31 and 32, and left and right attachment frames 34 and 35 which are formed of plate-like members and which are respectively fixated at the lower end parts of the left and right side frames 31 and 32 and attached to the left and right back side frames 7 and 8 so as to rotate freely.

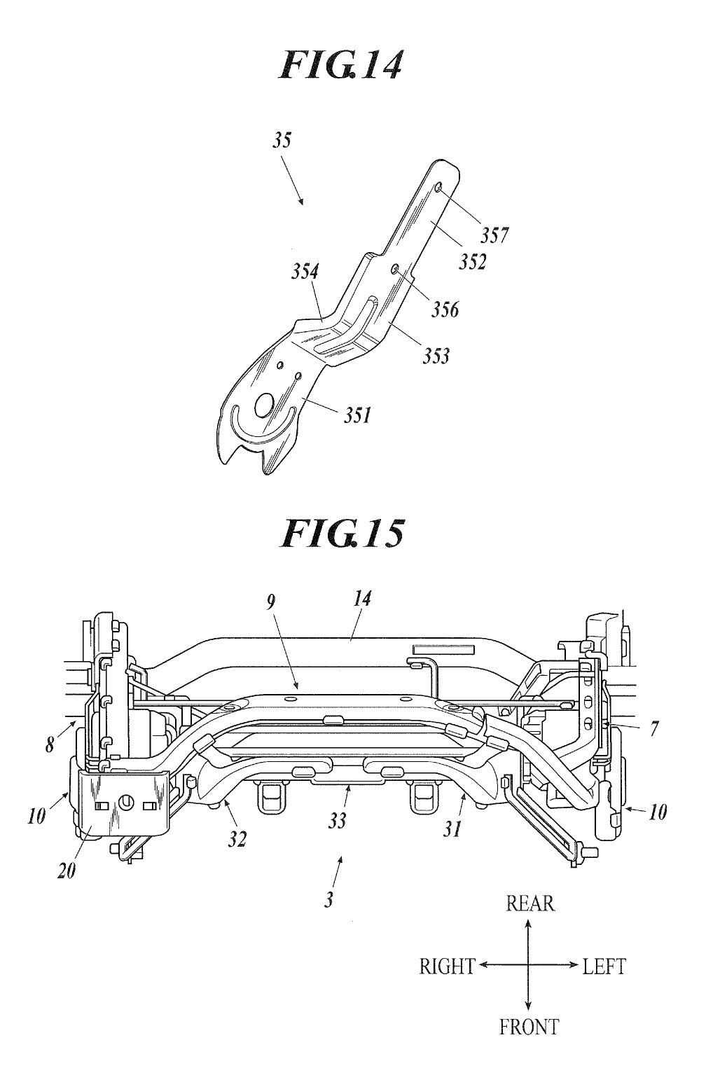

FIG. 14 is a schematic view showing an outline configuration of the right-side attachment frame 35. The left-side attachment frame 34 has a configuration that is basically the same as the configuration of the right-side attachment frame 35. Therefore, the same symbols are used for similar parts and their description is omitted.

As shown in FIG. 14, the attachment frame 35 includes a lower end part 351 as a connector which is to be connected to the back side frame 8 so as to rotate freely, an upper end part 352 as a fixation unit to which the side frame 32 is to be fixated, and a center part 353 which connects the lower end part 351 and the upper end part 352. The attachment frame 35 is formed so that the width is gradually widened toward the lower end part 351 from the upper end part 352. The center part 353 is curved so that the upper end part 352 is to be arranged inside than the lower end part 351. At the front and back edges of the center part 353, ribs 354 and 355 that extend toward outside are formed so as to extend in the up and down directions.

At the upper end part 352 of the attachment frame 35, through holes 356 and 357 that forms a pair for fixating the side frame 32 are formed with a predetermined space therebetween.

As shown in FIG. 3, at the lower end part 351 of the left-side attachment frame 34, the biasing mechanism 80 which applies a predetermined bias force to the movable frame 3 is connected.

As shown in FIGS. 3 and 13, each of the left and right side frames 31 and 32 is formed of one sheet of metal plate, and while it extends along the up and down directions as a whole, only the upper end part thereof is curved toward inside. With respect to each of the left and right side frames 31 and 32, ribs 311 and 312 that extend inward are respectively formed at the front and back edges thereof along the up and down directions. The ribs 311 and 312 are continuously formed at the curved parts near the upper end parts of the side frames 31 and 32, and the ribs 311 are formed at the upper edges of the upper end parts and the ribs 312 are formed at the lower edges of the upper end parts. Therefore, the upper end parts of the side frames 31 and 32 form cross-sectional U-shapes which open toward the front.

Since the ribs 311 and 312 of the left and right side frames 31 and 32 and the ribs 354 and 355 of the attachment frames 34 and 35 are projected in opposite directions, the ribs 311, 312, 354 and 355 do not exist on the surfaces where the left and right side frames 31 and 32 and the attachment frames 34 and 35 are to be assembled to each other. In such way, the left and right side frames 31 and 32 and the attachment frames 34 and 35 can be assembled to each other easily and their rigidity can also be improved.

At the lower end parts of the left and right side frames 31 and 32, pairs of through holes 313 and 314 respectively facing pairs of through holes 356 and 357 of the attachment frames 34 and 35 are formed. By inserting the bolts 85 through the through holes 356, 357, 313 and 314 and by fastening them by nuts 86, the side frames 31 and 32 and the attachment frames 34 and 35 are fixated.

At between the through holes 313 and 314 and thereabove, a plurality of reinforcement pipes 88 which bridge between the left and right side frames 31 and 32 are provided.

The connecting member 33 is formed of one plate member where the center part 331 thereof forms a convex shape frontward. Further, their two end parts 332 and 333 are respectively fit between the ribs 311 and 312 of the left and right side frames 31 and 32. At the two end parts of the connecting member 33, head rest supporting units 334 and 335 to which the head rest (not shown) is to be assembled are respectively attached.

The two end parts 332 and 333 of the connecting member 33 are curved downward toward the tips so as to correspond to the shapes of the upper end parts of the left and right side frames 31 and 32.

By having such shape, the left and right side frames 31 and 32 and the connecting member 33 curve out so as to form a convex toward the back as a whole when seen from above.

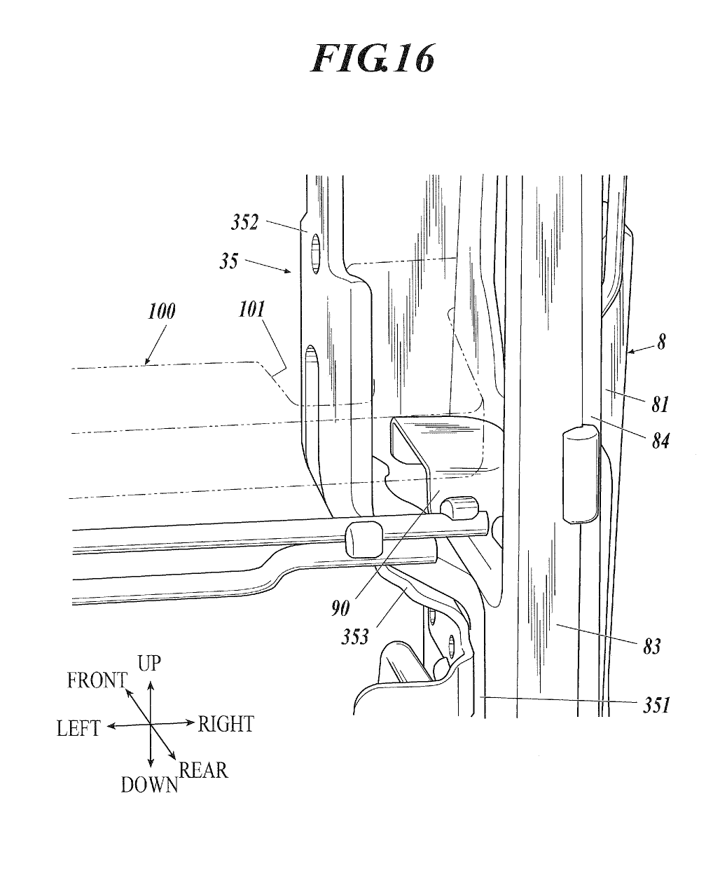

FIG. 15 is a top view of the outline configuration of the seat back frame 2 and the movable frame 3 when seen from above. As shown in FIG. 15, the movable frame 3 curves out so as to form a convex toward the back along the curve of the seat back frame 2 that curves out so as to form a convex toward the back.

A seat pad 100 is assembled to the seat back frame 2 and the movable frame 3.

FIG. 16 is an enlarged schematic view showing a partial positional relation between the seat back frame 2, the movable frame 3 and the seat pad 100. Although only the right side positional relation is shown in FIG. 16, the left side has the same positional relation as the right side. Therefore, the left side is omitted in the drawing.

As shown in FIG. 16, the seat pad 100 engages with the movable frame 3. In particular, the seat pad 100 is provided with cutouts 101 that engage with the attachment frames 34 and 35 of the movable frame 3. Therefore, at the part outside of the cutouts 101 of the seat pad 100, the seat pad 100 is disposed between the attachment frames 34 and 35 and the back side frames 7 and 8. Therefore, the inner surfaces of the back side frames 7 and 8 respectively include pad supporting members 90 which support parts of the seat pad 100 from below, the pad supporting members 90 extending inward.

As described above, according to the embodiment, the movable frame 3 is formed by assembling the plurality of plate members (the left and right side frames 31 and 32, the connecting member 33 and the left and right attachment frames 34 and 35). Therefore, the movable frame 3 can be made thinner comparing to a conventional movable frame which is formed of pipe members. Further, since a plurality of plate members are assembled, the plurality of plate members can be assembled so as to overlap each other at parts where the loads applied thereto are large and the rigidity at the parts can be assured. Therefore, while ensuring rigidity of the movable frame 3, the movable frame 3 can be made thinner.

Furthermore, since the movable frame 3 is formed of a plurality of plate members, the plate members are easier to be treated comparing to pipe members and a movable frame 3 having more complicated design can be formed.

Moreover, since the upper end parts of the left and right side frames 31 and 32 are connected by the connecting member 33, the parts near the upper parts of the side frames 31 and 32 can be connected firmly by the connecting member 33. For example, great load is applied to the upper part of the movable frame 3 since the head rest is assembled thereto via the head rest supporting units 334 and 335. However, by the upper part of the movable frame 3 being firmly connected by the connecting member 33, the stability of the headrest can be improved.

Further, since the upper end parts of the left and right side frames 31 and 32 respectively curve and extend toward inside, rigidity of the side frames 31 and 32 themselves can be improved by the curved parts.

Furthermore, since the upper end parts of the left and right side frames 31 and 32 are respectively formed in a cross-sectional U-shape opened frontward, rigidity of the upper end parts of the side frames 31 and 32 themselves can be improved by the cross-sectional U-shaped parts.

Moreover, since the connecting member 33 is arranged inside the cross-sectional U-shapes at the upper end parts of the left and right side frames 31 and 32, rigidity of the connecting member 33 after assembly can also be improved.

Further, since the center part 331 of the connecting member 33 curves out so as to form a convex frontward, rigidity of the connecting member 33 itself can be improved by the convex part.

Furthermore, the attachment frames 34 and 35 are formed so that their widths gradually widen as approaching the lower end parts 351 which are connecting parts with the back side frames 7 and 8 from the upper end parts 352 which are fixation parts with the left and right side frames 31 and 32. Therefore, large areas can be assured at the connecting parts with the back side frames 7 and 8 and the attachment frames 34 and 35 can be respectively attached stably to the back side frames 7 and 8.

Moreover, the left and right side frames 31 and 32 and the connecting member 33 are curved out so as to form a convex to the back as a whole when seen from above. Therefore, a passenger can be supported so as to be held from behind. Therefore, the comfort level of the passenger can be improved.

Further, the left and right back side frames 7 and 8 are respectively provided with the pad supporting members 90 which support parts of the seat pad 100 from below. Therefore, the seat pad 100 can be prevented from sinking down by the pad supporting members 90 and the comfort level of the passenger can be assured.

One end part of the upper frame 9 which is formed of a plate member has a shape that gradually widens as approaching near the belt guide bracket 20 and is connected to a part near the belt guide bracket 20. Therefore, the upper frame 9 can be connected to the part near the belt guide bracket 20 with a greater contact area. Thereby, while preventing the upper frame 9 from becoming large as a whole, the force applied to the part near the belt guide bracket 20 can be received by a greater area. Therefore, the attachment rigidity of the belt guide bracket 20 can be improved and stability of the seatbelt can be improved even more.

Further, one end part of the upper frame 9 is directly connected to the belt guide bracket 20. Therefore, the force applied to the belt guide bracket 20 can be received directly by the one end part of the upper frame 9 and the attachment rigidity of the belt guide bracket 20 can be improved even more.

Furthermore, the lower part of one end part of the upper frame 9 is curved so that the connecting position of the upper frame 9 and the part near the belt guide bracket 20 be arranged below the lower end part of the belt guide bracket 20. Therefore, the one end part of the upper frame 9 can be widened. Thus, the connection strength between the upper frame 9 and the belt guide bracket 20 can be improved.

Moreover, the upper frame 9 is an assembly of the front-side plate member 91 and the back-side plate member 92 which are the two plate members, the front and back, so that the inside thereof is hollow. Therefore, while making the upper frame 9 be lighter, its rigidity can also be assured.

Further, since both the front-side plate member 91 and the back-side plate member 92 are connected to the belt guide bracket 20, the force applied to the belt guide bracket 20 can be received directly by the front-side plate member 91 and the back-side plate member 92. Therefore, the attachment rigidity of the belt guide bracket 20 can be improved even more.

At the connecting positions of the belt guide bracket 20 to the front-side plate member 91 and the back-side plate member 92, the cutouts 913 and 923 for fitting the belt guide bracket 20 are provided. Therefore, a space can be assured by the cutouts 913 and 923 and a sufficient size of the belt guide bracket 20 can be assured.

Further, the front-side plate member 91 is connected to the left back side frame 7 so as to overlap from the front covering a wider range comparing to the connecting region of the back-side plate member 92 and the left back side frame 7. Therefore, a wide range of contacting area with respect to the left back side frame 7 can be assured, and the upper frame 9 and the left back side frame 7 can be connected firmly.

Moreover, the connecting position of the belt guide bracket 20 with the front-side plate member 91 is arranged at the back of the step formed by the first walls 211 and 212 of the first bracket member 21 and the second walls 223 and 224 of the second bracket member 22. Therefore, the connecting position can be fit in the space formed by the step and can be formed in a compact manner.

Further, the pad supporting members 90 which support parts of the seat pad 100 from below are provided at the left and right back side frames 7 and 8. Therefore, the pad supporting member 90 can prevent the seat pad 100 from sinking down and the comfort level of a passenger who is seated on the seat can be assured.

Furthermore, the back side frames 7 and 8 are respectively divided in the up and down directions and the armrest brackets 10 are respectively fixed to the overlapping regions G1 and G2 of the upper side frames 71 and 81 and the lower side frames 72 and 82. Therefore, the armrest brackets 10 are respectively to be supported by the overlapping regions G1 and G2. Since the overlapping regions G1 and G2 are parts where two plate members are overlapped, the armrest brackets 10 can be supported more firmly comparing to the case where they are each supported by one plate member, and the attachment rigidity of the armrest brackets 10 can be improved.

Moreover, the armrest brackets 10 are respectively fixed to the lower side frames 72 and 82 in the overlapping regions G1 and G2. Therefore, the load the armrest brackets 10 receive can be supported by the lower side frames 72 and 82 which are more stable comparing to the upper side frames 71 and 81. Thus, stability of the armrests and the armrest brackets 10 can be improved.

The armrest brackets 10 are respectively fixed to the overlapping regions G1 and G2 so that the rotary shafts 11 of the armrests project frontward from the overlapping regions G1 and G2. As described above, since two plate members are overlapped at each of the overlapping regions G1 and G2, the regions have high rigidity. Further, the armrest brackets 10 are respectively fixed to the overlapping regions G1 and G2 so that the rotary shafts 11 of the armrests project frontward from the overlapping regions G1 and G2. Therefore, while holding back the length of the armrests themselves, their length at use, that is, the projecting lengths when the armrests are in a horizontal state can be assured.

Further, the side frame connecting member 14 is bridged from the part near the overlapping region G1 or G2 to the back side frame 7 or 8 on the other side. Therefore, the parts near the overlapping regions G1 and G2 are reinforced by the side frame connecting member 14 and the attachment rigidity of the armrest bracket 10 can be improved even more.

The embodiment to which the present invention can be applied is not limited to the above described embodiment and can be modified as needed within the scope of the invention.

For example, in the above embodiment, an example where the armrest brackets 10 are respectively attached to the left and right back side frames 7 and 8 is described. However, an armrest bracket 10 may be attached only to at least one of the back side frames 7 and 8.

Further, in the above embodiment, an example where one end part of the upper frame 9 is directly connected to the belt guide bracket 20 is described. However, one end part of the upper frame 9 may be connected to a part of the right back side frame 8 near the belt guide bracket 20.

Moreover, in the above embodiment, an example where the belt guide bracket 20 is attached only to the right back side frame 8 among the left and right back side frames 7 and 8 is described. However, belt guide brackets 20 may be respectively attached to both of the back side frames 7 and 8.

### INDUSTRIAL APPLICABILITY

The seat device according to the present invention can be applied to a seat device to be mounted on a vehicle, for example.

### EXPLANATION OF REFERENCE NUMERALS

1 seat device
2 seat back frame
3 movable frame
4 cushion side frame
5 reclining mechanism
6 seat frame
7 back side frame
8 back side frame
9 upper frame
10 armrest bracket
11 rotary shaft
12 box-shaped unit
13 cover unit
14 side frame connecting member
20 belt guide bracket
21 first bracket member
22 second bracket member
31, 32 side frame
33 connecting member
34, 35 attachment frame
71 upper side frame
72 lower side frame
81 upper side frame
82 lower side frame
83 inside frame
84 outside frame
90 pad supporting member
91 front-side plate member
92 back-side plate member
100 seat pad
101 cutout
211, 212 first wall
221 top unit
222 front unit
223, 224 second wall
331 center part
332, 333 two end parts
351 lower end part
352 upper end part
353 center part
913, 923 cutout
G1 overlapping region
G2 overlapping region

1. A seat device, comprising:
a seat back frame; and
a movable frame which is arranged inside the seat back frame and which tilts freely in front and back directions with respect to the seat back frame, wherein
the movable frame is formed of plate members.

2. The seat device according to claim 1, wherein
the movable frame includes:
left and right side frames which are each formed of a plate member; and
a connecting member which is formed of a plate member and which connects upper parts of the left and right side frames.

3. The seat device according to claim 2, wherein
the upper parts of the left and right side frames are respectively curved and extended toward inside and the connecting member is connected to the extended parts.

4. The seat device according to claim 3, wherein
the upper parts of the left and right side frames are formed so as to have cross-sectional U-shapes opened frontward, and the connecting member is arranged inside the cross-sectional U-shapes at the upper parts of the left and right side frames.

5. The seat device according to claim 2, wherein a center part of the connecting member is formed to have a convex toward a front.

6. The seat device according to claim 2, wherein
the movable frame further includes left and right attachment frames which are each formed of a plate member, which are fixed at respective lower parts of the left and right side frames and which are attached to the seat back frame so as to rotate freely, and
the attachment frames are formed so as to be widened toward connection parts with the seat back frame from fixation parts with the left and right side frames.

7. The seat device according to claim 2, wherein
the left and right side frames and the connecting member are curved out so as to form a convex toward a back as a whole when seen from above.

8. The seat device according to claim 1, further comprising a seat pad engaging with the movable frame, wherein
pad supporting members for supporting parts of the seat pad from below are provided at left and right back side frames of the seat back frame.

9. The seat device according to claim 1, further comprising a belt guide bracket to which a belt guide of a seatbelt is to be fixated, wherein
the seat back frame includes left and right back side frames and an upper frame which connects upper parts of the left and right back side frames,
the belt guide bracket is attached to an upper end part of at least one of the left and right back side frames,
the upper frame is formed of plate members, and
an end part of the upper frame is connected to a part near the belt guide bracket in the at least one of the left and right back side frames and the end part of the upper frame has a shape where a width thereof widens toward the belt guide bracket.

10. The seat device according to claim 9, wherein the end part of the upper frame is connected directly to the belt guide bracket.

11. The seat device according to claim 9, wherein a lower part of the end part of the upper frame is curved so that a connecting position with the part near the belt guide bracket is arranged below a lower end part of the belt guide bracket.

12. The seat device according to claim 9, wherein the upper frame is formed of two plate members, and a front-side plate member and a back-side plate member are assembled so that inside thereof is hollow.

13. The seat device according to claim 12, wherein both the front-side plate member and the back-side plate member are connected to the belt guide bracket.

14. The seat device according to claim 13, wherein cutouts for fitting the belt guide bracket is provided at the connecting position of the front-side plate member and the back-side plate member with the belt guide bracket.

15. The seat device according to claim 12, wherein
the belt guide bracket includes:
a first bracket member which engages with the upper end part of the at least one of the left and right back side frames so as to cover a back of the at least one of the left and right back side frames; and
a second bracket member which engages with the upper end part of the at least one of the left and right back side frames so as to cover a front of the at least one of the left and right back side frames, wherein
the first bracket member includes left and right first walls which are arranged so as to have the upper end part of the at least one of the left and right back side brackets between the left and right first walls,
the second bracket member includes left and right second walls which are arranged so as to have the first walls of the first bracket member between the left and right second walls, and
a connecting position of the belt guide bracket with the front-side plate member is arranged at a back of a step formed by the first walls and the second walls.

16. The seat device according to claim 9, comprising the movable frame which is arranged inside the seat back frame and which tilts freely in the front and back directions with respect to the seat back frame,
wherein
the movable frame and the seat back frame are curved out so as to form a convex toward a back when seen from above.

17. The seat device according to claim 1, further comprising an armrest bracket for supporting an armrest,
wherein
the seat back frame includes left and right back side frames,
the armrest bracket is fixed to at least one of the left and right back side frames,
the back side frame to which the armrest bracket is fixated is divided into an upper side frame and a lower side frame in up and down directions,
a lower end part of the upper side frame and an upper end part of the lower side frame are unified so as to overlap, and
the armrest bracket is fixed to the overlapping region of the upper side frame and the lower side frame.

18. The seat device according to claim 17, wherein
the lower side frame is arranged so as to overlap the upper side frame from outside, and
the armrest bracket is fixed to the lower side frame in the overlapping region.

19. The seat device according to claim 17, wherein the armrest bracket supports the armrest so that the armrest rotates freely, and the armrest bracket is fixated to the overlapping region so that a rotary shaft of the armrest projects forward from the overlapping region.

20. The seat device according to claim 17, further comprising a side frame connecting member which is bridged from a part near the overlapping region to the other back side frame.
